(19) United States
(12) Patent Application Publication
(10) Pub. No.: US 2025/0323930 A1
(43) Pub. Date: Oct. 16, 2025

(54) SYSTEM AND METHOD FOR MODELING AND PRIORITIZATION OF ATTACK PATHS IN NETWORK ENVIRONMENTS

(71) Applicant: Leidos, Inc., Reston, VA (US)

(72) Inventors: Cooper Linsky, Columbia, MD (US); J. Marc Brasher, San Antonio, TX (US); Todd Jaspers, Lithia, FL (US); Robert Lindsay Allen, San Antonio, TX (US)

(73) Assignee: Leidos, Inc., Reston, VA (US)

(21) Appl. No.: 18/950,351

(22) Filed: Nov. 18, 2024

Related U.S. Application Data
(60) Provisional application No. 63/633,276, filed on Apr. 12, 2024.

(51) Int. Cl. H04L 9/40

(52) U.S. Cl. CPC H04L 63/1433; H04L 63/1425

(57) ABSTRACT

An attack path modeling and discovery system and process of the present combines comprehensive network data with machine learning to determine the greatest risk to a network environment by exposing the path of least resistance an attacker would likely take. This system and process considers both the likelihood of a threat agent to exploit a vulnerability, and the potential for loss when that threat occurs. The system utilizes two key models to accomplish this goal. First, Knowledge Graphs (KG) are leveraged to comprehensively model relationships across an environment, and second, Graph Neural Networks (GNNs) are used to predict the path of least resistance to the network's user-defined most valuable assets.

### CROSS-REFERENCE TO RELATED APPLICATIONS

The present application claims the benefit of priority to U.S. Provisional Patent Application No. 63/633,276 entitled SYSTEM AND METHOD FOR MODELING AND DISCOVERY OF ATTACK PATHS IN AN ENTERPRISE NETWORK filed Apr. 12, 2024, which is incorporated herein by reference in its entirety.

### BACKGROUND

### Field of Embodiments

The field of the embodiments is a system and method for identifying attack paths representing vulnerability exploitation and authentication service traversal across realizable network accesses and quantifying prioritization of attack path risk with deep learning.

### Description of Related Art

Enterprise networks are frequently audited and assessed for both compliance and the discovery of vulnerability. By conducting vulnerability assessments, security analysts typically receive a list of security and configuration issues that exist on that network. Generally, these reports are sorted by individual endpoint severity and administrators will proceed to patch, fix, or remediate the highest severity systems first. These assessments may contain upwards of thousands of issues depending on the size of network. Typically, less severe issues may never be resolved due to inadequate resourcing. Moreover, prioritization for remediation is often inherently flawed where emphasis is instead placed on meeting compliance requirements, rather than the overall contextual connective, systemic, and functional risk of the issues and vulnerabilities.

A computer-associated vulnerability's rating is typically based on severity ratings such as the Common Vulnerability Scoring System (CVSS), a mathematical function that predicts a vulnerability's severity from 0 to 10. A score of 0 represents no severity and a score of 10 represents the most critical severity. These scoring systems, while valuable, consider computers as isolated sub-components and lack overall contextual information from the network at large. For example, if two vulnerabilities are identified in a network, one with a CVSS score of 5 and the other with a score of 9, it's a safe assumption that the CVSS 9 item would be prioritized first for remediation by a security team. However, if the endpoint with a CVSS 5 ranked vulnerability has direct access to the most sensitive segments of the network, an attacker would seek to compromise this system first. Through this compromise of the CVSS 5 ranked system, the attacker would be able to disrupt and degrade key functions of the business. With a different situational awareness, the order in which vulnerabilities are remediated in an enterprise drastically changes.

Attack paths are a representative model of connections across a network's assets, and the exploitation an attacker can leverage to traverse them. They can be used to identify the easiest steps of exploitation (e.g., shortest path) from users to sensitive network segments or resources. In the field of Cybersecurity, these sensitive segments and resources are often termed the “Key Cyber Terrain”. By identifying attack paths to an environment's Key Cyber Terrain, administrators and security personnel gain invaluable situational awareness; the realistic actions an attacker would likely take to access a business' most valuable resources.

One type of attack path involves misconfigurations and weaknesses in enterprise authentication services. Authentication services play a crucial role in managing user permissions and access to network and system resources, ensuring the security and confidentiality of sensitive data. For instance, a system administrator may assign users of a finance department to a finance group and only grant them access to databases containing financial records. While the principle of least privilege is widely practiced, meaning that users are granted only the minimal required permissions to perform their tasks effectively, small misconfigurations or oversights in authentication services can leave networks susceptible to exploitation. The attack paths of these authentication services expose those weaknesses, which if left unpatched, could allow an attacker to elevate their privileges or an insider threat to gain access to resources beyond their authorized scope.

Another technique utilized by attackers to traverse a network involves vulnerability exploitation; weaknesses in software or services that can be exploited to gain increased or additional access. Vulnerabilities are commonly categorized by the Common Vulnerabilities and Exposures (CVE) labeling system, which documents system vulnerabilities and assigns them unique identifiers. For example, CVE-2022-23943 is a vulnerability affecting certain versions of Apache HTTP Server, which could permit an attacker to execute arbitrary code. This vulnerability can be used to grant an attacker access to a vulnerable endpoint and if compromised, possibly a foothold on the network. Once vulnerable endpoints have been identified, prior attack path solutions form connections (or edges) between them with passive scanning. Scanning involves systematically examining network devices, including (but not limited to) computers, routers, switches, and firewalls, to detect and identify vulnerabilities or anomalous behavior. Passive scanning typically involves monitoring data packets flowing through the network, which includes information about communicating endpoints such as IP address and ports. With the data procured from passive scans, prior solutions infer connections between endpoints contingent upon evidence of communication between the endpoints, as discerned from the network traffic. By connecting these vulnerable endpoints, prior solutions construct attack paths, effectively mapping the potential for vulnerability exploitation.

Such attack paths solutions that model vulnerability exploitation fail to offer comprehensive situational awareness of actual networking availability. The methodology of forming edges through passive scanning is inherently limited. Importantly, an absence of observed communication between two systems does not equate to an inability for these systems to communicate. For example, two systems may have the capability for communication, yet their interaction has not been captured in the network traffic. This is a significant blind spot in the understanding of actual networking availability. Consequently, the vast majority of potential paths, which an attacker could realistically exploit, may fail to be identified.

Current solutions generate attack paths based solely on either authentication service misconfigurations or vulnerability exploitation, treating these as separate entities. This individualistic approach does not accurately portray the multifaceted strategies of an actual attacker. In real-world scenarios, attackers will employ both methods in concert to traverse networks and gain access to Key Cyber Terrain. For instance, an attacker could exploit a specific vulnerability in conjunction with several instances of authentication service misconfigurations to form an efficient attack path, a scenario that current solutions would fail to identify. By neglecting to incorporate the simultaneous use of vulnerability exploitability and authentication misuse in their models, these solutions fail to capture the full range of possible attack paths an attacker might employ. This illustrates the urgent need for a more comprehensive system and method capable of modeling attack paths that integrates both elements. Such a system would provide a more accurate representation of potential attack paths and, consequently, a more robust defensive strategy.

Prior solutions for attack path modeling exhibit a significant limitation in their ability to assign meaningful prioritization or severity to attack paths. These solutions prioritize remediation based on the number of exploits or “hops” needed to access a network's Key Cyber Terrain. However, this approach fails to align with the strategic thinking and behavior of an attacker, who would prioritize the path of least resistance, not necessarily the shortest one. Consider, for instance, Advanced Persistent Threats (APTs) which are equipped with extensive capabilities and funding to achieve their objectives. These advanced attackers have much more at stake when conducting operations, which is known as operational risk. Risk can be categorized into distinct segments and then weighted before taking an action. Before any action is performed, these actors attempt to determine the risk to access their target (i.e., a network), to their capabilities being compromised (advanced software being signatured), to being detected, or the operation being attributed (i.e., to the country of origin). As such, attackers need to acquire an advanced understanding of the network to assess the risk of a particular action, with the ultimate aim of finding the path of least resistance to achieve their goals. In stark contrast to this nuanced strategy, existing products and solutions naively use the number of “hops” as a metric for assigning business risk. However, in practice, an APT is generally indifferent to the number of hops. For instance, given a choice between a 3-hop attack with high risk and a 6-hop attack path with minimal to no risk, an APT would opt for the longer path with less risk. The longer path is less likely to trigger detection, lead to loss of capabilities, or result in attribution. This strategic approach underlines the need for defenders to maintain comprehensive monitoring across all systems and vulnerability management, ensuring total visibility of their environment and enabling swift response to network threats. More importantly, it highlights the imperative for a novel model that can prioritize attack paths based on the path of least resistance, as opposed to merely the number of hops away. Such a model would significantly enhance the understanding of potential attack paths, culminating in better management of network threats.

U.S. Pat. No. 9,043,920 for System and method for identifying exploitable weak points in a network, U.S. Pat. No. 11,032,298 for System and method for continuous collection, analysis and reporting of attack paths in a directory services environment, and U.S. Patent Publication No. US20210064762A1 for Intelligent Adversary Simulator provide exemplary descriptions of existing systems and methods for identifying network attack paths and are incorporated herein by reference in their entirety.

### SUMMARY OF THE EMBODIMENTS

In a first exemplary embodiment, a system for modeling network data as a knowledge graph includes: a knowledge graph ontology for network scans that infers vulnerability exploitation, a knowledge graph ontology for authentication service scans that infers authentication service misconfigurations, a knowledge graph ontology for network traffic configurations that infers network reachability, a process that forms connections between endpoints based on said reachability, and a process that populates ingested network data into a unified, holistic knowledge graph.

In a second exemplary embodiment, a machine learning model architecture which ranks the resistance of attack paths includes: a lookup table containing learnable embeddings for recognized ATT&CK Techniques, a lookup table containing learnable embeddings for recognized Common Weakness Enumerations (CWE) for additional vulnerability context, a lookup table containing learnable embeddings for computers, wherein each embedding is representative of the computer's operating system; a lookup table containing learnable embeddings for significant ports, a lookup table for graph nodes given embeddings irrespective of their properties, a lookup table specifically for graph edge embeddings, an embedding model for CVEs, wherein the model processes the description and various properties of the vulnerability as a sequence of tokens and generates several, representative embeddings; and a graph neural network that predicts the node weights of a graph over multiple iterations indicative of attack path risk.

In a third exemplary embodiment, a process for training a machine learning model to quantify attack path risk includes: the construction of a ground-truth attack path dataset, with each sample comprising an input, a graph that represents at least two attack paths to a specified endpoint, and a label—a ranking of possible paths based on their resistance; embedding the graphs, wherein each node and edge is designated an embedding; predicting the weight of each node in the graph with a graph neural network over several iterations, and the optimization of embeddings, embedding models, and graph neural network through an optimization strategy that aligns the sum of node weights for each path with the ground truth path ranking.

### BRIEF DESCRIPTION OF THE FIGURES

Example embodiments will become more fully understood from the detailed description given herein below and the accompanying drawings, wherein like elements are represented by like reference characters, which are given by way of illustration only and thus do not limit the exemplary embodiments herein.

FIG. 1 shows high-level schematic of an exemplary attack path modeling and discovery system in accordance with embodiments herein.

FIGS. 2A and 2B show exemplary knowledge graph ontologies for vulnerability scans (FIG. 2A), and network configurations and reachability (FIG. 2B) in accordance with embodiments herein.

FIG. 3 shows the process by which ingested data is processed and populated into a unified, holistic knowledge graph in accordance with embodiments herein.

FIGS. 4A and 4B show exemplary knowledge graph ontologies for attack path traversal representing realizable vulnerability exploitation, authentication service traversal, and network configurations in accordance with embodiments herein.

FIG. 5 shows an exemplary attack path graph to Key Cyber Terrain utilizing both vulnerability exploitation and authentication service misconfigurations in accordance with embodiments herein.

FIG. 6 shows the quantitative performance of the encoder-based transformer trained to provide numerical representations (embeddings) of CVEs in accordance with embodiments herein.

FIG. 7 shows the quantitative performance of the Graph Neural Network model trained to quantify attack path risk in accordance with embodiments herein.

### DETAILED DESCRIPTION

As discussed below, the attack path modeling and discovery system and process of the present embodiments, combines comprehensive network data with machine learning to determine the greatest risk to the network by exposing the path of least resistance an attacker would likely take. This considers both the likelihood of a threat agent to exploit a vulnerability, and the potential for loss when that threat occurs. The system utilizes two key models to accomplish this goal. First, Knowledge Graphs (KG) are leveraged to comprehensively model relationships across an environment, and second, Graph Neural Networks (GNNs) are used to predict the path of least resistance to the network's customer-defined most valuable assets.

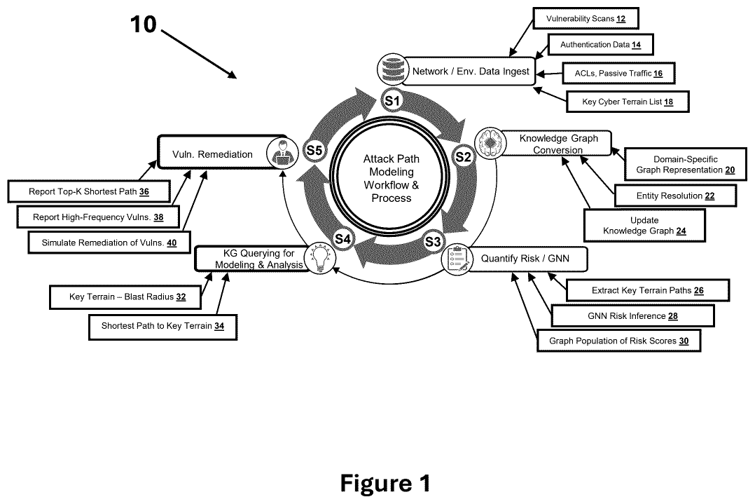

FIG. 1 is a high-level schematic of an exemplary attack path modeling and discovery system 10 for implementing the embodiments described herein. The process for identifying network attack paths starts with the ingestion of information from the network environment at S1. Data ingested by the system can be categorized into three primary sources: data on endpoints exposing vulnerabilities 12, data on authentication services 14, and data on the network's configuration 16. Additional ingested data may include identified key cyber terrain list 18.

Data regarding network endpoints and their associated vulnerabilities 12 can be ingested from any scanning or host-based tools that generates vulnerability data and reports, e.g., Nessus vulnerability scanning tool, Nmap network mapper tool or CrowdStrike Falcon Spotlight module. Irrespective of the collection method or the format it is presented in, this data will encompass details on endpoints, applications, and vulnerabilities. Endpoints are typically identified by their hostname, IP address, MAC address, or operating system (OS). Applications running on these endpoints can be characterized based on their communication protocol, application version, port number in use, and the OS service they employ. In this context, applications refer to software programs or services running on an endpoint. Vulnerabilities are recognized weaknesses in the security configurations of operating systems or applications that could potentially be exploited by malicious actors. Information included on vulnerabilities is commonly, but not necessarily, sourced from the Common Vulnerabilities and Exposures (CVE) system, providing comprehensive details such as a detailed description, corresponding risk score (e.g., Common Vulnerability Scoring System (CVSS)), and Common Weakness Enumeration (CWE) details that outline the underlying hardware or software weaknesses that the vulnerability exploits.

To enrich the typical data provided on vulnerabilities, the system herein incorporates mapping vulnerabilities to the MITRE ATT&CK framework. The ATT&CK framework is an open-source knowledge base of adversarial tactics and techniques commonly used in security operations, threat intelligence, and security architecture. By mapping vulnerabilities to the ATT&CK Framework, users gain insights into “how” vulnerabilities might be exploited, as well as “why” an attacker would choose to do so. Each vulnerability is mapped to one or more ATT&CK technique, which describes “how” the vulnerability gets exploited. In turn, each ATT&CK technique falls under an ATT&CK tactic, “why” an attacker would exploit the vulnerability. For instance, vulnerability CVE-2021-27319 is “Blind SQL injection in contactus.php in Doctor Appointment System 1.0 allows an unauthenticated attacker to insert malicious SQL queries via email parameter.” This vulnerability gets mapped to ATT&CK technique T1059, representing an attacker using a command or scripting interpreter to exploit a vulnerability. This technique is associated with tactic TA0002, where an attacker exploits a vulnerability to execute malicious code. By mapping CVE-2021-27319 to the ATT&CK Framework, a user can easily understand that this vulnerability is exploited by using a command or scripting interpreter, for the purpose of executing malicious code.

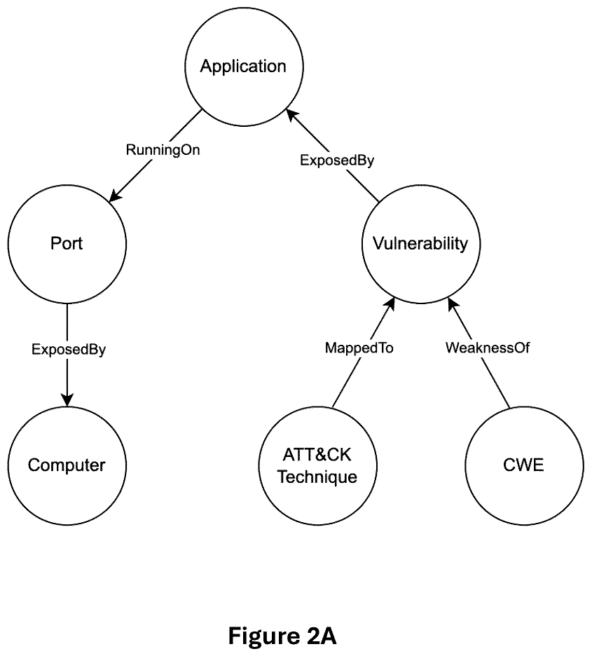

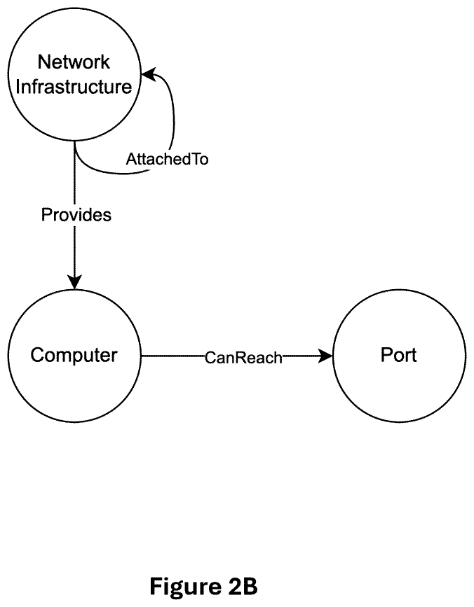

Next, the ingested data is converted into a knowledge graph S2 using a domain-specific graph representation 20 (i.e., ontology). In a preferred embodiment, the ontology consists of nodes for computers, ports, applications, vulnerabilities, CWEs, and ATT&CK techniques. The computer node is linked to the port node, indicating a port that serves as an interface for the computer. Given the potential for a computer to have up to 65,535 ports, this relationship presents an issue of graph scalability and increased verbosity, the latter of which may compromise the interpretability usually associated with knowledge graphs. The number of connections between computers and their respective ports can be managed by filtering based on open ports, ports running applications, or ports that expose vulnerabilities. The port node is linked to the application node, signifying an application running and binding to a port. Applications rely on ports to send and receive necessary traffic for its functionality. The application node is linked to the vulnerability node, indicating the vulnerabilities an endpoint is exposed to by running the respective application. Lastly, the ATT&CK technique and CWE nodes are linked to the vulnerability node, providing additional context regarding vulnerabilities. This ontology effectively represents vulnerability scan data as a knowledge graph. FIG. 2A provides an exemplary knowledge graph in accordance with S2. As described further herein, as part of conversion of the ingested data and updating the knowledge graph 24, the process also performs entity resolution 22.

Crucial to accurate attack path modeling is the comprehension of the communication abilities between systems. An attacker cannot exploit vulnerabilities or misuse authentication services to reach a target if network access isn't possible, making network accessibility a key component in modeling attack paths. To achieve a more accurate representation of available attack paths, network configuration data can be collected either actively, through system-to-system scanning for available ports, or manually, through the ongoing collection of routing tables, access control lists (ACLs), and firewall configurations 16. Tools used for this collection include, but are not limited to, Nmap, Nessus, and network configuration and mapping tools. Routing tables, ACLs, and firewall configurations are all critical components used in a network environment. Routing tables guide the forwarding of packets within a network, directing the traffic flow between different networks. ACLs, on the other hand, control access to network services by defining who is allowed or denied access to certain parts of a network. Firewall configurations establish rules for what traffic is permitted or denied, acting as the first line of defense in network security by controlling both inbound and outbound traffic. These network structures can be used to infer network connections and provide a more accurate understanding of the communication availability between systems. Active collection offers a snapshot of the network at a specific point in time, but typically requires more effort for collection. In contrast, ongoing collection of network configurations offers the most accurate and comprehensive representation of communication availability. This approach ensures up-to-date knowledge, providing a more realistic picture of the network's state and thus allowing for a more precise modeling of potential attack paths.

FIG. 2B demonstrates the high-level ontology framework for network configuration data, which is structured around three nodes: network infrastructure, computer endpoints, and port nodes. The network infrastructure node represents devices such as routers, firewalls, and switches that manage and direct traffic within a network. An edge node, denoted as “AttachedTo”, connects the network infrastructure node to itself, indicating the routing of traffic between these devices. For example, a router in a local area network (LAN) might be “AttachedTo” a switch, signifying that traffic from the router is routed to the switch. Furthermore, the network infrastructure node has a “Provides” edge that links to endpoints. This edge node represents the first device that traffic is routed through after leaving an endpoint. For instance, in a typical network setup, a switch might be the first device that “Provides” for an endpoint, after which the traffic is directed through various network infrastructure nodes via the “AttachedTo” edge node. By examining routing tables, which detail the routes between the endpoints, the interconnections within the network are inferred and edges are accordingly constructed in the knowledge graph. The endpoint node, in turn, has an edge labeled “CanReach” connecting to the port node. This edge indicates a potential communication pathway from one endpoint to another through a specific port. This connectivity information is derived from examining routing tables, Access Control Lists (ACLs), and firewall rules. If it's determined that two computers, say Computer A and Computer B, can communicate, the communication-enabled ports on Computer B are identified. Subsequently, edges are formed between Computer A and the corresponding communication-enabled ports on Computer B. To illustrate, if Computer A can communicate with Computer B through Port 22, an edge labeled “CanReach” would be formed from Computer A to Port 22 on Computer B. This ontology effectively encapsulates network configuration data, providing a comprehensive and precise understanding of the communication capabilities between systems within a network.

Authentication services are a core component of a network infrastructure. They serve to verify the identity of users and devices attempting to access resources or applications within a network. This process is crucial for maintaining security and ensuring only authorized entities have access to sensitive data. Several popular types of authentication services include Active Directory (AD), Lightweight Directory Access Protocol (LDAP) servers, RADIUS servers, and Single Sign-On (SSO) solutions. While not limited thereto, in a preferred embodiment, the system herein also utilizes Active Directory, Microsoft's proprietary directory service, due to its widespread use in managing user identities and access permissions in enterprise settings. Active Directory serves as a centralized repository for storing entities that support the authentication process, such as user, group, Organizational Unit (OU), and Group Policy Object (GPO) data. The user entity represents individual identities within an organization and includes the username, password, and various attributes such as department, location, or job title. These details can be used to enforce access policies and grant permissions based on user roles or group memberships. Groups are a collection of users that share common access privileges to resources or applications within a network. Group membership determines the level of access granted to members, enabling efficient management of permissions across an organization. Organizational Units are logical containers for organizing objects within Active Directory, such as Users, Groups, and Computers. They provide a hierarchical structure that simplifies the management of complex environments by allowing administrators to apply policies and configurations to specific sets of objects. Group Policy Objects define the configuration settings for various aspects of a network, including security policies, software installation, and desktop configurations. These GPOs enable administrators to enforce standardized policies across an organization and maintain a consistent environment.

Data within Active Directory can be ingested in several ways. The Lightweight Directory Access Protocol (LDAP) offers a flexible approach to accessing and manipulating directory data through a simple request-response model. Alternatively, Microsoft Graph API offers a more advanced and programmatic way to access and manage Active Directory data. This interface provides comprehensive support for managing users, groups, OUs, and other entities while enabling integration with various applications and services that rely on AD data.

Ingested authentication service data 14 is transformed into a knowledge graph using an ontology based on Authentication Services. By way of example only, BloodHound, an open-source software tool for visualizing Active Directory environments, is an example of such a service. The Authentication Service ontology features distinctive nodes representing Users, Groups, Computers, Group Policy Objects (GPOs), Organizational Units (OUs), Containers, and Domains, all integral components of an Active Directory environment. Along with the nodes, the Authentication Service ontology establishes various relationships between these entities, depicted as edges within the graph. These edges symbolize different relationships existing in the Active Directory environment. For example, an edge from a User node to a Group node can signify a user's membership in a specific group. Similarly, an edge from a User node to a Computer node can reflect a user's active session on a particular computer.

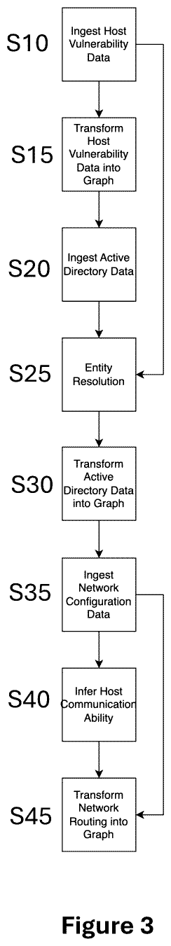

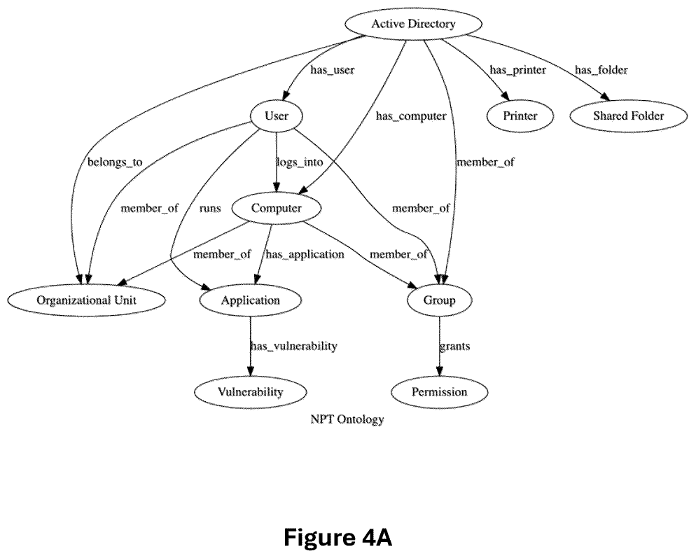

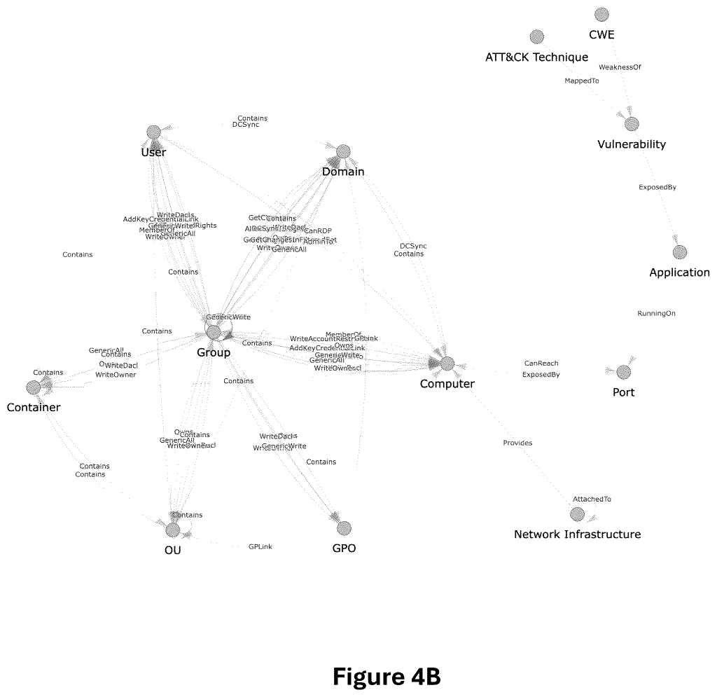

FIG. 3 details the process S2 of transforming the different categories of ingested data into a unified, comprehensive knowledge graph (FIG. 4). The process S2 begins with the ingestion of network endpoint data and their associated vulnerabilities S10, gathered from one or more active scanning tools. This data, which includes endpoints running applications that expose vulnerabilities, the ports these applications operate on, and additional metadata about the vulnerabilities, is then transformed into relevant nodes in the knowledge graph S15 such as that exemplified in FIG. 2A.

Subsequently, the system ingests network authentication services data S20, i.e., active directory data, which comprises information about Users, Groups, Computers, Group Policy Objects (GPOs), Organizational Units (OUs), Containers, and Domains. This network authentication services data is converted into a knowledge graph that highlights potential active directory permission misconfigurations that an attacker could exploit. The intersection point between these nodes and the vulnerability exploitation nodes is the Computer endpoint node. While active scanners identify endpoints by their IP or MAC address, active directory identifies endpoints by their domain name or unique global identifier. In addition, IP addresses of endpoints are continuously changing as a result of Dynamic Host Configuration Protocol (DHCP). To resolve these discrepancies and create a unified representation, an entity resolution process is undertaken S25. This process matches the identifiers to the same node, ensuring that if a computer was already populated into the knowledge graph from active scanning, any additional edges would be linked to the same node, representing its connections to the network active directory. The ingested network authentication services data is transformed into a knowledge graph S30.

Next, for each computer in the knowledge graph, network configuration data, i.e., ACLs, routing tables, and firewall rules are ingested to infer the reachability between endpoints S35. For every pair of endpoints in the graph, these network configurations are examined to determine whether they can communicate S40. Notably, network communication is not inherently bidirectional. For example, if Computer A and Computer B were sampled for determining communication, it is being determined whether Computer A can transmit data for Computer B. At a specific point in the process, whether Computer B can transmit data to Computer A will also be determined. If it is the case that one endpoint can transmit data to another, the ports for the computer receiving data are examined. For each port for the computer receiving data in the knowledge graph, if the computer sending data has the ability to reach it, then a “CanReach” edge is formed between the sender computer and the receiving port. This edge is utilized to model an attacker “hopping” from one endpoint to another and exploiting some vulnerability disclosed by an application operating on the port. The ingested network configuration data is transformed into a knowledge graph S45.

A key enhancement to existing Authentication Service ontologies in this system is the incorporation of network configuration data derived from Access Control Lists (ACLs) and firewall rules. This is a crucial addition as prior art Authentication Services does not inherently consider networking reachability, such as whether a user can use the Remote Desktop Protocol (RDP) to connect to another endpoint from their current endpoint. The system herein uses network configuration data to eliminate edges that depict unattainable or impossible connections, thereby providing a more accurate representation of the network's actual state.

Lastly, network infrastructure nodes are populated to represent the routing between endpoints. This is critical context, as the more devices that capture traffic from an attacker on a network, the more likely they are to be discovered. For each pair of endpoints in the knowledge graph that can communicate, routing tables are ingested to discover the route traffic would take between them. The corresponding devices are populated into the knowledge graph, and edges are formed to model the exact path that traffic would take between them. This knowledge graph (KG) ontology offers two critical contributions. First, it models attack paths that occur leveraging both authentication service misconfigurations and vulnerability exploitation. Second, it models realistic network accesses which is critical for modeling accurate attack paths. Exemplary KG ontologies are shown in FIG. 4A (simple) and FIG. 4B (complex).

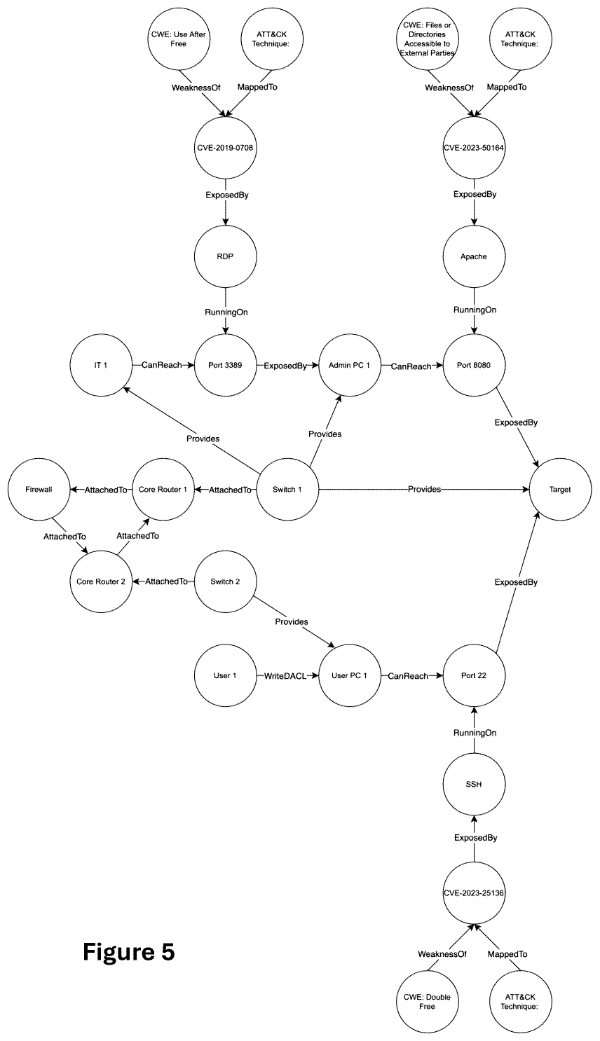

Data in the knowledge graph representation is stored within a graph database, for instance, Neo4j. When a user identifies an endpoint (e.g., target) as Key Cyber Terrain, the graph database can be queried to reveal the potential paths an attacker might use to reach it. FIG. 5 illustrates an exemplary attack path graph that includes two potential paths to a particular target. For example, one of the attack paths in the graph begins with the presumption that User 1, is the entry point. To begin, an attacker could manipulate the Active Directory permissions related to User 1 to grant themselves access to User PC 1, as shown by the “WriteDACL” connection. Subsequently, the attacker could utilize the communication capability between User 1 and the Target, in combination with a vulnerability on the target, to achieve access to Target, as indicated by the “CanReach” connection. To summarize, the attack path is User1→WriteDACL→User PC 1→CanReach→Port 22→ExposedBy→Target. Our attack path ontology classifies connections into two categories: those representing exploitation, and those providing context. While other nodes and connections linked to the mentioned attack path exist, they only serve to provide context. For example, by navigating the nodes connected to Port 22, additional details about the exploited vulnerability can be uncovered. In this situation, it can be observed that the exploit was achieved by a vulnerability exposed by SSH, the vulnerability leveraged is CVE-2023-25136, and the vulnerability corresponds to the CWE Double Free. The attack graph includes three network infrastructure devices: a firewall, Core Router 1, and Core Router 2. These nodes and their associated connections provide context on the routing between endpoints. The other attack path in the graph is IT 1→CanReach→Port 3389→ExposedBy→Admin PC 1→CanReach→Port 8080→ExposedBy→Target. It can be observed that these three computers share routing on the same switch. On the other hand, User PC 1 and Target are configured on different switches. To reach Target from User PC 1, traffic would be routed from Switch 2 to Core Router 2, to Core Router 1, to Switch 1, and finally the target. From a networking perspective, this is a riskier route than exploiting endpoints on the same switch. While this does not guarantee one path being riskier than the other, it is crucial context that must be considered in prioritizing attack paths.

As exemplified by Advanced Persistent Threats, attack path prioritization is a complex problem. This complexity requires more sophisticated solutions than are currently available, specifically, the use of machine learning. Machine learning, with its ability to model complex tasks, presents a proficient approach to the intricate task of attack path prioritization. A machine learning approach operates on three key components: a dataset, a model architecture, and an optimization technique. The dataset provides the necessary information used to train the model. The architecture, which refers to a structured set of algorithms and layers that dictate the flow of calculations within the model, defines how the model processes and extracts features from the data. The architecture can include layers for convolution (for image-based data), recurrent steps (for sequential data), or dense connections (for tabular data). The architecture's design can significantly influence the model's ability to capture intricate patterns and make accurate predictions. Lastly, the optimization technique guides the model's learning process by minimizing errors and improving the accuracy of predictions.

The dataset is comprised of many examples of possible attack paths to a specific target. Each example is ranked by a subject matter expert, who orders the attack paths based on the perceived level of resistance, from least to most. The resistance of an attack path is determined by various factors, such as the vulnerabilities exploited, the misuse of authentication services, and the network routing involved. In machine learning, a dataset is generally represented by inputs and labels. In this framework, the input to the machine learning model is the attack graph, which contains all paths to a particular target, while the label is the expert-determined ranking of all possible paths based on their resistance. This dataset, characterized by the attack graphs and their corresponding rankings, forms the ground truth used to train the machine learning model.

In machine learning, an embedding is a numerical, vector representation of an object that captures the object's characteristics and semantic meaning. Embeddings are necessary for machine learning models as they can encode complex objects such as words, sentences, or even entire documents into a simplified, numeric form that can be understood. In this system of the preferred embodiments, embeddings are used to represent various elements of the network, modeled with nodes and edges. For example, each computer, port, application, vulnerability, and even each type of connection between these elements is represented by an embedding. The embeddings capture the unique characteristics of these elements, enabling the machine learning model to incorporate these features when determining the resistance of an attack path. The embeddings used in this system are learnable, meaning that they are iteratively updated during the training process to improve the model's performance. This concept is similar to that of models like ChatGPT, a large language model, where each word or sub word provided to the language model has a learnable embedding. The embeddings are initially assigned random values, but as the model is trained on the dataset, the embeddings are updated based on the error between the model's predictions and the actual labels. Over time, the embeddings become more representative of the elements they encode, ultimately improving the model's performance.

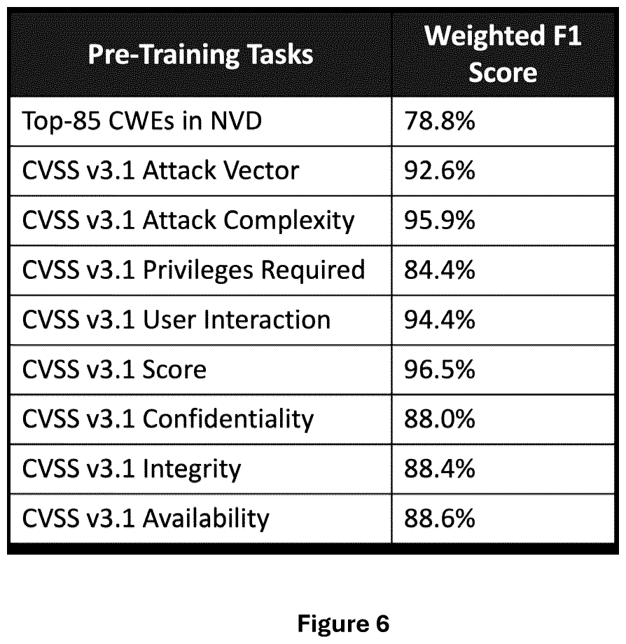

Grasping how vulnerabilities factor into attack path risk stands as one of the most intricate elements of the analysis. An encoder-based transformer was trained on a dataset of 150,000 Common Vulnerabilities and Exposures (CVEs) sourced from the National Vulnerability Database (NVD). This training was undertaken with the objective of generating meaningful embeddings for CVEs. Specifically, the model is engineered to encode textual descriptions of CVEs, in conjunction with a spectrum of vulnerability properties represented as special tokens. These special tokens encapsulate 85 distinct categories of Common Weakness Enumerations (CWEs), as well as the 8 fundamental metrics of the Common Vulnerability Scoring System (CVSS) version 3.1: Attack Vector, Attack Complexity, Privileged Required, User Interaction, Score, Confidentiality, Integrity, and Availability. By strategically masking these special tokens and learning to classify them, the model is optimally equipped for an array of downstream tasks related to text representations of vulnerabilities. FIG. 6 illustrates the performance of the CVE encoder on these nine tasks.

In the proposed system of the preferred embodiments, every node and every edge in the attack graph is embedded. This includes nodes representing different elements like GPO, Domain, OU, User, Container, and Group, each of which has its own unique embedding. Certain other nodes are given embeddings with consideration for their properties. For instance, each supported CWE and each supported ATT&CK Technique has its own unique embedding. For managing the potentially large number of port nodes, only a certain number of ports are given unique embeddings. The most popular ports have unique embeddings, and all other ports share the same embedding. This approach balances the need for specificity with the practical constraints of managing a large number of unique embeddings. Vulnerability nodes have embeddings that are computed using the aforementioned CVE encoder. These embeddings capture the semantic meaning of the description as well as various fundamental properties of the vulnerability. Embeddings for application nodes are computed as a function of the number of known CVEs associated with the application, and whether the application uses additional layers of authentication, such as Multi-Factor Authentication (MFA). On the other hand, embeddings for network infrastructure nodes are derived based on whether the communication between two systems is tapped (i.e., with a spanning port) and whether network traffic is recorded and monitored. This is particularly important for modeling the behavior of an attacker, who would consider these factors when prioritizing paths. Endpoint node embeddings are computed as a function of the endpoint's operating system, whether the system is centrally managed and/or has endpoint detection software, and whether the system has remote logging or backup software. Every edge in the graph has its own embedding, except for the “CanReach” edge. The embedding for the “CanReach” edge is computed as a function of how frequent or normal it is for the two systems to communicate. This provides a quantitative measure of the likelihood of communication between two systems, adding another layer of detail to the model's understanding of the network.

A Graph Neural Network (GNN) is a type of machine learning model that extends the capabilities of traditional neural networks to operate directly on graphs. GNNs are particularly suited for processing graph data because they are designed to leverage the structural information of graphs. In the proposed attack path model and process 10, a GNN is utilized to process individual attack paths and quantity risk S3, i.e., extract key terrain paths, 26, predict a numerical score reflecting the attack path's resistance against an attacker 28 and graph the population of risk scores 30. To do this, the GNN operates through several iterative layers, during which it continually refines the embeddings of both nodes and edges based on the information gleaned from their neighboring components within the graph. This process is crucial as it enables the GNN to capture the dependencies and interactions between network elements in the graph, which is essential for accurately predicting exploitability. While not limited thereto, in a preferred embodiment, the GNN leverages a graph transformer architecture, which leverages multi-head self-attention to process the attack paths. Following the GNN's multi-layer processing, the updated node embeddings, which encapsulate the GNN-processed information, are subjected to a standard neural network layer that predicts a numerical score for each endpoint node in the attack path. These individual endpoint node scores serve to compute an aggregate score for the attack path. This is done by summing the scores of the endpoint nodes within each attack path, yielding a total score that signifies the path's overall exploitability and provides a measure of its resistance.

Given the cumulative risk score for each path, the GNN and embeddings are optimized to ensure alignment between the model's predictive path scores and the ground truth ordering. The ground truth ordering is the expert-determined ranking of attack paths based on their resistance, as provided in the dataset. The model's optimization process is guided by a loss function, a mathematical function that quantifies the discrepancy between the model's predictions and the actual labels. Preserving optimal ordering is commonly leveraged in the field of information retrieval where the objective is to arrange a set of documents in order of their relevance to a specific query. This is similar to ensuring that search results from a search engine (e.g., Google, Bing) query are highly relevant to the user's search terms. In the context of attack path modeling, the analogous goal is to rank a set of attack paths based on their resistance to exploitation. Several loss functions, such as ListNet, LambdaRank, and LambdaLoss, can be employed for this task. Each of these loss functions provides a distinct approach to the problem of learning to rank, and the chosen loss function can significantly influence the model's performance. Regardless of the loss function selected, all meet the overarching goal of preserving the orderings of the paths.

When the attack graphs consist of three or more attack paths, the metric leveraged for quantifying the ranking's performance is normalized discounted cumulative gain (nDCG). The nDCG metric evaluates the quality of a ranking by considering both the relevance of each item in the list and its position in the ranking. In terms of attack path modeling, the nDCG metric can be interpreted as follows: the more relevant attack paths are those with less resistance, therefore more likely for an attacker to take, and should be ranked higher in the list. For example, consider three attack paths, A, B, and C to a specific target. According to an expert's assessment, path A is the riskiest, followed by path B, and then path C. This forms the ground truth ranking of [A, B, C]. The model's task is to predict a similar ranking based on the resistance scores it calculates for each path. Suppose the model predicts the ranking as [B, A, C]. This prediction is not entirely accurate, as path B is predicted to be riskier than path A, contrary to the ground truth. The nDCG metric quantifies this discrepancy by assigning higher weights to paths that are riskier (i.e., less resistant) and appear earlier in the list. Hence, a higher nDCG score indicates a better alignment between the model's predictions and the ground truth, and thus a better performance of the model.

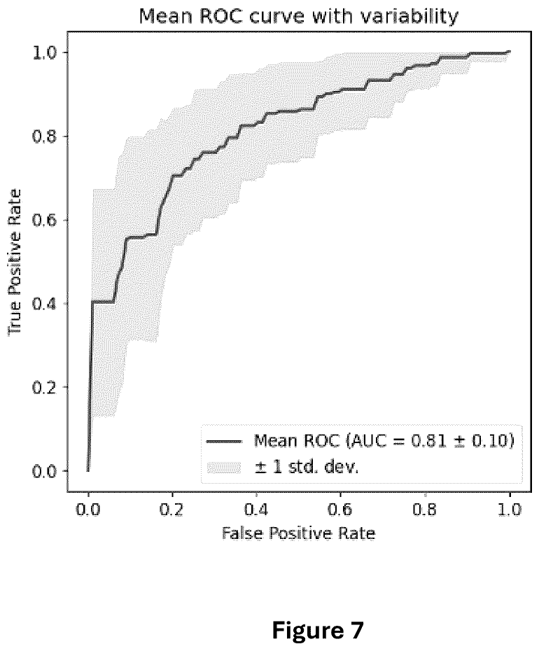

In cases where the attack graphs comprise only two attack paths, the Area Under the Curve (AUC) is the metric used to quantify the performance of the ranking. A receiver operating characteristic (ROC) curve visually represents the trade-off between the false positive rate and true positive rate of a binary classifier, with the AUC being the area beneath this ROC curve-a widely accepted quantitative measure of a binary classifier's performance. One such optimization technique of the GNN can generate a continuous numeric risk score, while also modeling the probability of one attack path being riskier than another. This simplifies the problem to a binary classification, enabling evaluation with AUC. As depicted in FIG. 7, the GNN model, trained to quantify attack path risk, demonstrates efficacious quantitative performance. It indicates that given two attack paths, the GNN has an 81% probability of assigning a higher risk score to the riskier path.

The attack path modeling and discovery system and process described herein facilitates identification of attack patterns through machine learning assisted path of least resistance discovery, which allows users (defender) to more appropriately prioritize their risks to the network. In steps S4 and S5 of the process 10, users can take steps to ascertain key terrain blast radius 32 and shortest path to key terrain 34 as well as mitigating risks based on the potential for these attack “paths” to be successful. Vulnerability remediation S5 may be facilitated using top-k shortest path report 36, high-frequency vulnerabilities report 38 and simulated remediations of vulnerabilities 40.

The system is accessible via an API, such as FAST API and JSON, which may be integrated with other user products and provides users the ability to define specifically, what exactly is important in their network, and not just the canned targets such as the domain controller or mail server. This allows users to apply the system to their unique situation, such as a SCADA environment, a research lab, or other type of non-standard environment.

It will be understood that the descriptions of one or more embodiments do not limit the various alternatives, modified and equivalent embodiments which may be included within the spirit and scope of the embodiments as defined by the appended claims. Furthermore, in the detailed description above, numerous specific details are set forth to provide an understanding of various embodiments. However, one or more embodiments may be practiced without these specific details. In other instances, well known methods, procedures, and components have not been described in detail so as not to unnecessarily obscure aspects of the present embodiments.

We claim:

1. A system for modeling a network environment to expose potential attack paths to endpoints therein, comprises:
a knowledge graph generation component for receiving network environment data, the knowledge graph generation component further comprising,
a first knowledge graph ontology wherein vulnerability scan data received at the knowledge graph generation component from one or more active network scanners is mapped thereto and infers vulnerability exploitation within the network environment,
a second knowledge graph ontology wherein authentication service data received at the knowledge graph generation component is mapped thereto and infers authentication service misconfigurations within the network environment,
a third knowledge graph ontology wherein network configuration data received at the knowledge graph generation component is mapped thereto and infers network reachability within the network environment,
wherein the knowledge graph generation component merges the first knowledge graph ontology with scan data mapped thereto, the second knowledge graph ontology with authentication service data mapped thereto and the third knowledge graph ontology with network configuration data mapped thereto to produce a unified knowledge graph for the network environment, the unified knowledge graph including a mapping of connections between endpoints in the network environment based reachability thereto.

2. The system of claim 1, wherein vulnerability scan data includes recognized weaknesses in the security configurations of endpoints or applications within the network environment as determined by the one or more active network scanners.

3. The system of claim 1, wherein endpoints are identified in the vulnerability scan data at least one of hostname, IP address, MAC address, or operating system (OS).

4. The system of claim 1, wherein applications running on endpoints are characterized in the vulnerability scan data by their communication protocol, application version, port number in use, and OS service they employ.

5. The system of claim 1, wherein the vulnerability scan data is enriched by mapping the recognized weaknesses to one or more known techniques for exploiting the recognized weaknesses.

6. The system of claim 1, wherein authentication service data includes user identity data and access permissions data for individual user access to resources and applications, including endpoints, within the network environment.

7. The system of claim 6, wherein the authentication service data is available from at least one from a group including an Active Directory (AD), a Lightweight Directory Access Protocol (LDAP) server, a RADIUS server, and a Single Sign-On (SSO) solution.

8. The system of claim 1, wherein the network configuration data includes routing tables, access control lists (ACLs), and firewall configurations with the network environment.

9. A machine learning model architecture which ranks resistance of attack paths to endpoints within a network environment from an attack path knowledge graph, comprising:
a first lookup table containing learnable embeddings for recognized network environment attack technique nodes;
a second lookup table containing learnable embeddings for recognized network environment weakness indicator nodes;
a third lookup table containing learnable embeddings for network environment operating system feature nodes;
a fourth lookup table containing learnable embeddings for certain network environment port nodes;
a fifth lookup table for attack path knowledge remaining graph node embeddings;
a sixth lookup table specifically for attack path knowledge graph edge embeddings;
an embedding model for common network environment vulnerabilities, wherein the embedding model processes attributes of each common network vulnerability as a sequence of tokens and generates representative embeddings therefor; and
a graph neural network for predicting node weights of the attack path knowledge graph over multiple iterations indicative of attack path risk.

10. The machine learning model architecture of claim 9, wherein the embedding model for common network environment vulnerabilities is an encoder-based transformer for encoding textual descriptions of the common network environment vulnerabilities in conjunction with a spectrum of vulnerability properties represented as special tokens.

11. The machine learning model architecture of claim 9, wherein the remaining attack path knowledge graph nodes include application nodes whose embeddings are computed as a function of a number of common network environment vulnerabilities associated with the application and whether the application uses one or more additional layers of authentication.

12. The machine learning model architecture of claim 9, wherein remaining attack path knowledge graph nodes include network infrastructure nodes whose embeddings are derived based on whether communication between two systems is tapped and whether network traffic is recorded and monitored.

13. The machine learning model architecture of claim 9, wherein the certain network environment port nodes have unique embeddings, and all other port nodes share the same embedding.

14. A process for training a machine learning model to quantify attack path risk for identified attack paths to endpoints within a network environment from an attack path knowledge graph of the network environment, the process comprising:
constructing a ground-truth attack path dataset, wherein each sample within the dataset includes an input, a graph representing at least two known attack paths to a specified endpoint, and a label indicating a ranking of the at least two known attack paths based on a resistance path to the specified host for each of the at least two known attack paths;
embedding the attack path knowledge graphs using an embedding model, wherein each node and edge of the attack path knowledge graph is designated as an embedding;
predicting a weight of each node in the attack path knowledge graph with a graph neural network over several iterations; and
optimizing the embeddings and graph neural network by aligning a sum of node weights for each identified attack path with the ground-truth attack path labels.

15. The process for training a machine learning model of claim 14, wherein each nodes include elements of the network environment selected from a group consisting of a Group Policy Object (PO), a Domain, Organizational Unit (OU), a User, a Container, and a Group.

16. The process for training a machine learning model of claim 14, wherein the nodes include recognized network environment attack technique nodes each having unique embeddings and recognized network environment weakness indicator nodes each having unique embeddings.

17. The process for training a machine learning model of claim 14, wherein the nodes include ports in the network environment, wherein a subset of ports have unique embeddings and remaining ports have a same embedding.
